(19) United States
(12) Patent Application Publication
(10) Pub. No.: US 2016/0111880 A1
(43) Pub. Date: Apr. 21, 2016

(54) POWER CONTROLLER, POWER CONTROL METHOD, AND POWER CONTROL SYSTEM

(71) Applicant: KYOCERA CORPORATION, Kyoto (JP)

(72) Inventor: Ryota TERAI, Yokohama-shi, Kanagawa (JP)

(21) Appl. No.: 14/892,963

(22) PCT Filed: May 23, 2014
(86) PCT No.: PCT/JP2014/002732

§ 371 Date: Nov. 20, 2015

(30) Foreign Application Priority Data
May 23, 2013 (JP) 2013-109208

(51) Int. Cl. H02J 3/28; G05B 15/02

(52) U.S. Cl. CPC H02J 3/28; G05B 15/02

(57) ABSTRACT

A power controller, power control method, and power control system that enable prompt operation depending on the situation after a power failure are provided. A power controller includes: a communication unit (121) configured to acquire sensor data relating to a load apparatus (18) or a dispersed power source (15, 16); a nonvolatile storage unit (25) and a volatile storage unit (125) each configured to store the sensor data; a control unit (124) configured to control the load apparatus (18) or the dispersed power source (15, 16) based on the sensor data; and a backup power source (123) that is charged with a power source, and supplies power during a power failure, wherein the control unit (124) is configured to, when starting the power controller after the power failure, store the sensor data in the volatile storage unit (125) while the backup power source (123) is being charged, and store the sensor data in the nonvolatile storage unit (25) after the backup power source (123) is completely charged.

### CROSS REFERENCE TO RELATED APPLICATION

This application claims priority to Japanese Patent Application No. 2013-109208 (filed on May 23, 2013), the entire disclosure of which is incorporated herein by reference.

### TECHNICAL FIELD

The disclosure relates to a power controller, a power control method, and a power control system.

### BACKGROUND

The technique of controlling, by a power controller (e.g. energy management system (EMS)) installed in each consumer's facility of electric power, load apparatuses, dispersed power sources, or the like in the power consumer's facility has been known in recent years. In a conventional power controller, the power consumption of each load apparatus is detected by a power sensor, and sensor data acquired by the detection is transmitted to a server or the like. The server or the like transmits a control signal according to the power consumption of each load apparatus while monitoring the power consumption, so that the power consumption of each load apparatus is efficiently reduced.

In the case where the power supply to the power controller is interrupted due to a power failure or the like, the acquired sensor data is lost unless the data is stored in a nonvolatile storage medium such as flash memory. Besides, in the case where the power supply is interrupted while the data is being written to the nonvolatile storage medium, the data is likely to be corrupted.

In view of this, it has been conventionally proposed to connect any apparatus that is not allowed to stop operation due to a power failure, to an uninterruptible power supply (UPS) (for example, Patent Literature (PTL) 1). With the technique of PTL 1, when power fails, the UPS supplies power and, while power is being supplied from the UPS, apparatuses lower in priority are stopped, thus preventing the power controller from stopping due to the power failure.

### CITATION LIST

### Patent Literature

PTL 1: JP 2007-43802 A

### SUMMARY

### Technical Problem

The technique of PTL 1 enables operation even during a power failure, through the use of the UPS. The use of the UPS, however, requires higher cost. In the case where a large capacitor capable of operating for a while during a power failure is used instead of the UPS, the cost and the apparatus size increase. By using a capacitor whose capacity is just enough to execute necessary processes such as properly shutting down apparatuses during a power failure, such increases in cost and apparatus size can be avoided. Even in this case, however, when the capacitor is used, the power controller is not restarted until a backup power source is completely charged. This hinders prompt operation of the power controller.

It could therefore be helpful to provide a power controller, power control method, and power control system that enable prompt operation depending on the situation after a power failure.

### Solution to Problem

We provide the following.

A power controller installed in a consumer's facility to manage a power state of a load apparatus or a dispersed power source in the consumer's facility, includes: a communication unit configured to acquire sensor data relating to the load apparatus or the dispersed power source; a nonvolatile storage unit and a volatile storage unit each configured to store the sensor data; a control unit configured to control the load apparatus or the dispersed power source based on the sensor data; and a backup power source that is charged with a commercial power source, and supplies power during a power failure, wherein the control unit is configured to, when starting the power controller after the power failure, store the sensor data in the volatile storage unit while the backup power source is being charged, and store the sensor data in the nonvolatile storage unit after the backup power source is completely charged.

In the power controller, a condition for the control unit starting the power controller after the power failure includes a situation where current time is in a final part of a reference period for measuring power usage.

In the power controller, a condition for the control unit starting the power controller after the power failure includes a situation where predicted power usage within a reference period based on the sensor data before the power failure is greater than or equal to a set value.

In the power controller, the dispersed power source includes a power storage, and a condition for the control unit starting the power controller after the power failure includes a situation where the power storage is not discharging.

In the power controller, the dispersed power source includes a power generator, and a condition for the control unit starting the power controller after the power failure includes a situation where the power generator is not discharging.

In the power controller, the dispersed power source includes a solar power generator, and a condition for the control unit starting the power controller after the power failure includes a situation where power generation of the solar power generator is less than a predetermined amount.

In the power controller, a condition for the control unit starting the power controller after the power failure includes a situation where a power usage reduction instruction is issued.

In the power controller, the control unit is configured to, when starting the power controller after the power failure, store only a part of the sensor data in the volatile storage unit while the backup power source is being charged.

The power controller further transmits the sensor data to a server, wherein the control unit is configured to, when starting the power controller after the power failure, transmit the sensor data to the server at intervals of a first predetermined time in the case where the backup power source has been completely charged, and transmit the sensor data to the server at intervals of a second predetermined time while the backup power source is being charged, the second predetermined time being shorter than the first predetermined time.

A power control method is a method by a power controller installed in a consumer's facility to manage a power state of a load apparatus or a dispersed power source in the consumer's facility, wherein the power controller includes: a communication unit configured to acquire sensor data relating to the load apparatus or the dispersed power source; a nonvolatile storage unit and a volatile storage unit each configured to store the sensor data; a control unit configured to control the load apparatus or the dispersed power source based on the sensor data; and a backup power source that is charged with a commercial power source, and supplies power during a power failure, and the power control method includes steps of, when starting the power controller after the power failure: storing the sensor data in the volatile storage unit while the backup power source is being charged; and storing the sensor data in the nonvolatile storage unit after the backup power source is completely charged.

In the power control method, a condition for the control unit starting the power controller after the power failure includes a situation where current time is in a final part of a reference period for measuring power usage.

In the power control method, a condition for the control unit starting the power controller after the power failure includes a situation where predicted power usage within a reference period based on the sensor data before the power failure is greater than or equal to a set value.

In the power control method, a condition for the control unit starting the power controller after the power failure includes a situation where a power storage is not discharging.

A power control system is a system including: a load apparatus or a dispersed power source in a consumer's facility; and a power controller for managing a power state of the load apparatus or the dispersed power source, wherein the power controller includes: a communication unit configured to acquire sensor data relating to the load apparatus or the dispersed power source; a nonvolatile storage unit and a volatile storage unit each configured to store the sensor data; a control unit configured to control the load apparatus or the dispersed power source based on the sensor data; and a backup power source that is charged with a commercial power source, and supplies power during a power failure, and the control unit is configured to, when starting the power controller after the power failure, store the sensor data in the volatile storage unit while the backup power source is being charged, and store the sensor data in the nonvolatile storage unit after the backup power source is completely charged.

In the power control system, the power controller further transmits the sensor data to a server, and the control unit is configured to, when starting the power controller after the power failure, transmit the sensor data to the server at intervals of a first predetermined time in the case where the backup power source has been completely charged, and transmit the sensor data to the server at intervals of a second predetermined time while the backup power source is being charged, the second predetermined time being shorter than the first predetermined time.

### Advantageous Effect

It is thus possible to provide a power controller, power control method, and power control system that enable prompt operation depending on the situation after a power failure.

### BRIEF DESCRIPTION OF THE DRAWINGS

In the accompanying drawings:

FIG. 1 is a block diagram schematically illustrating the configuration of a power control system including a power controller according to one of the disclosed embodiments;

FIG. 2 is a functional block diagram schematically illustrating the configuration of the power controller according to one of the disclosed embodiments;

FIG. 3 is a flowchart illustrating the operation of the power controller according to one of the disclosed embodiments;

FIG. 4 is a flowchart illustrating a first example of a start determination process;

FIG. 5 is a flowchart illustrating a second example of the start determination process;

FIG. 6 is a flowchart illustrating a third example of the start determination process;

FIG. 7 is a flowchart illustrating a fourth example of the start determination process;

FIG. 8 is a flowchart illustrating a fifth example of the start determination process; and

FIG. 9 is a flowchart illustrating the operation of a power controller according to a modification of one of the disclosed embodiments.

### DETAILED DESCRIPTION

The following describes one of the disclosed embodiments.

### Embodiment

A power control system including a power controller according to one of the disclosed embodiments is described below. A power control system including a power controller according to this embodiment includes at least one dispersed power source, in addition to power supplied from an electric power grid (commercial power source). Preferable examples of the dispersed power source include a solar power generation system for supplying power by solar power generation and a power storage system capable of charge and discharge.

The power generation system for supplying power is not limited to the solar power generation system for supplying power by solar power generation, but may be any of various power generation systems including a fuel cell system having fuel cells such as solid oxide fuel cells (SOFCs). This embodiment describes an example where a solar power generator is included as the power generation system and a power storage is included as the power storage system.

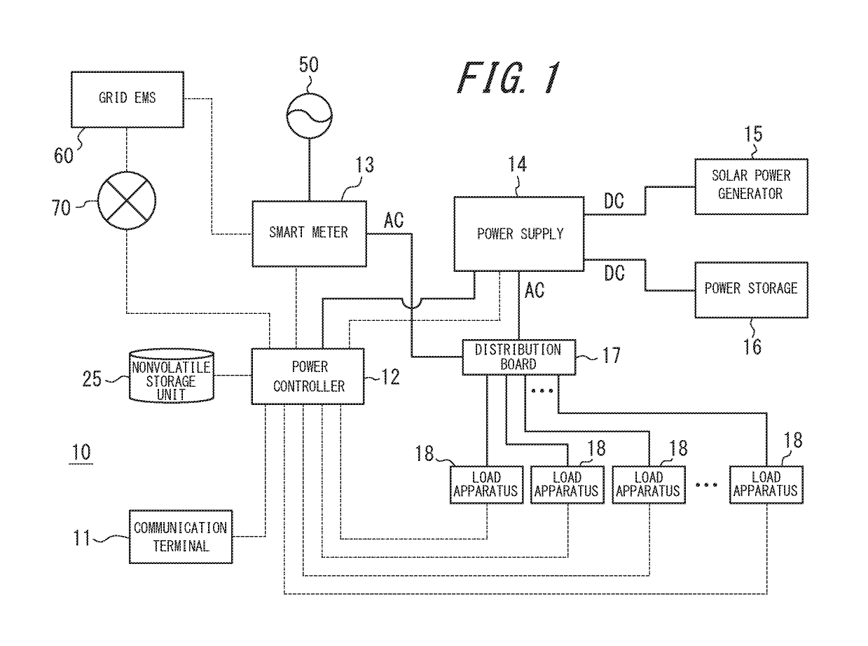

FIG. 1 is a block diagram schematically illustrating the configuration of a power control system 10 including a power controller according to one of the disclosed embodiments. The power control system 10 according to one of the disclosed embodiments includes a communication terminal 11, a power controller 12, a smart meter 13, a power supply 14, a solar power generator 15, a power storage 16, a distribution board 17, and one or more load apparatuses 18.

In FIG. 1, the solid lines between the functional blocks represent the flow of power, and the dotted lines between the functional blocks represent the flow of control signals or information communicated. The communication represented by the dotted lines may be wired communication or wireless communication. Wireless communication is performed via a wireless router. The wireless router may be included in the power controller 12, or installed separately from the power controller 12.

Various schemes are available for communication of information and control signals, including the physical and logical layers.

For example, the communication between the power controller 12 and each of the communication terminal 11, the smart meter 13, and the power supply 14 may be performed by a short-range communication scheme such as ZigBee®. The communication between the power controller 12 and each load apparatus 18 may be performed using various transmission media such as infrared communication and power line communication (PLC). Moreover, any of various communication protocols defining the logical layer, such as ZigBee SEP 2.0 (Smart Energy Profile 2.0) and ECHONET Lite®, may be operated on the physical layer suitable for each communication. The following describes an example where ECHONET Lite® is used when the power controller 12 communicates with the communication terminal 11, the smart meter 13, the power supply 14, and the load apparatuses 18.

The power control system 10 may supply not only power supplied from a commercial power source 50 but also power generated by the solar power generator 15 and power obtained by discharging the charged power storage 16, to the load apparatuses 18 and the power controller 12.

The communication terminal 11 displays information transmitted from the power controller 12. For example, the communication terminal 11 displays power consumption history information and the like.

The power controller 12 controls and manages the power of each apparatus in the power control system 10 illustrated in FIG. 1. The configuration of the power controller 12 will be described in detail later.

The smart meter 13 is connected to the commercial power source 50, and measures power supplied from the commercial power source 50. The smart meter 13 is also connected to the distribution board 17, and measures power generated by the solar power generator 15 and sold to an electric power company from the power supply 14 via the distribution board 17. The smart meter 13 may notify the power controller 12 of the measured power.

The smart meter 13 may also receive information such as power-related predictions from a grid energy management system (EMS) 60. The grid EMS 60 is a facility for performing various power-related predictions, controls, etc., and is typically installed in the electric power company or the like. For example, the grid EMS 60 may include a meter data management system (MDMS). The grid EMS 60 is connectable to an external network 70 such as the Internet.

The power supply 14 converts DC power supplied from the solar power generator 15 and the power storage 16 into AC power. The power supply 14 supplies the converted AC power to the load apparatuses 18 via a plurality of branches separated at the distribution board 17. In the case where there is a surplus of power generated by the solar power generator 15, the power supply 14 may sell the converted AC power to the electric power company via the distribution board 17. The power supply 14 may also convert AC power supplied from the commercial power source 50 into DC power for charging the power storage 16.

The solar power generator 15 generates power using sunlight. The solar power generator 15 includes solar cells, and converts energy from sunlight into DC power. It is assumed in this embodiment that the solar power generator 15 has a configuration in which a solar panel is mounted on, for example, the roof of a house to generate power using sunlight. The solar power generator 15, however, may have any configuration capable of converting energy from sunlight into electric power.

The power generated by the solar power generator 15, having been converted into AC power by the power supply 14, may be supplied to each load apparatus 18 and/or sold to the electric power company, as mentioned above. The power generated by the solar power generator 15 may also be used to charge the power storage 16. The DC power generated by the solar power generator 15 may be supplied to each load apparatus 18 without being converted into AC power.

The power storage 16 includes a storage battery, and may supply power by discharging the charged storage battery. The power storage 16 may also be charged with power supplied from the commercial power source 50, the solar power generator 15, etc. The power from the power storage 16 may also be supplied to the load apparatuses 18 and the power controller 12, as illustrated in FIG. 1. In the case of supplying power from the power storage 16 to the load apparatuses 18 and the power controller 12, the supply is switched from the power from the commercial power source 50 to the power from the power storage 16.

The distribution board 17 separates supplied power into a plurality of branches and distributes the power to the load apparatuses 18. Each of the branches may be connected directly to a representative load apparatus 18 that consumes a large amount of power, or connected to a group of load apparatuses 18 within the same room. The former load apparatus 18 is, for example, an air conditioner, a refrigerator, or an induction cooker. The latter load apparatus 18 is a load apparatus connected to any of several receptacles located in a room, and which load apparatuses are connected to receptacles are undefined.

In FIG. 1, any number of load apparatuses 18 may be connected in the power control system 10. These load apparatuses 18 are, for example, various electrical appliances such as a television, an air conditioner, and a refrigerator. These load apparatuses 18 are connected to the power supply 14 via the distribution board 17, and supplied with power.

The power controller 12 is described in more detail below.

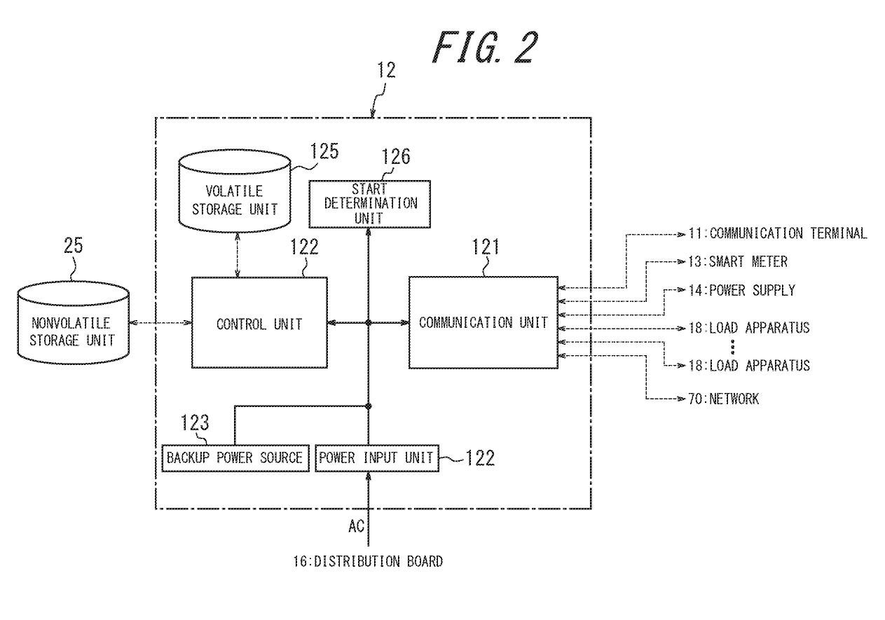

FIG. 2 is a functional block diagram schematically illustrating the configuration of the power controller 12 according to one of the disclosed embodiments. The power controller 12 is an EMS as an example, and includes a communication unit 121, a power input unit 122, a backup power source 123, a control unit 124, a volatile storage unit 125, and a start determination unit 126.

The communication unit 121 is an interface as an example, and transmits and receives information and control signals between the control unit 124 and each of the communication terminal 11, the smart meter 13, the power supply 14, and the load apparatuses 18.

For example, the communication unit 121 may acquire information of power purchased from and/or power sold to the commercial power source 50, from smart meter 13. The communication unit 121 may also acquire instruction information (hereafter referred to as “power usage reduction instruction”) of demand response (DR) relating to power usage reduction, from the electric power company or the like via the smart meter 13. The communication unit 121 may also acquire sensor data of power supplied from the solar power generator 15, the power storage 16, and the commercial power source 50 to the load apparatuses 18 via the plurality of branches separated at the distribution board 17, from the power supply 14 via sensors installed in the branches. The communication unit 121 may also directly acquire information on the amount of power (i.e. charging power) with which the power storage 16 is charged, from the power supply 14. The communication unit 121 may also directly acquire information on power consumption, from each load apparatus 18. The communication unit 121 may also acquire various information from the network 70.

The communication unit 121 may further acquire control signals from the communication terminal 11, and transmit information indicating the power control and management state in the power control system 10 to the communication terminal 11. The case of employing ECHONET Lite® is used as an example here.

The power input unit 122 receives power supplied from the commercial power source 50, the solar power generator 15, and the power storage 16 via the smart meter 13 and the distribution board 17.

The backup power source 123 includes a capacitor such as a supercapacitor, and is charged with the power (i.e. the power supplied from the commercial power source 50, etc.) received by the power input unit 122. In the case where the power input unit 122 receives no power from the commercial power source 50 due to a power failure, the charged backup power source 123 is discharged to supply power to the power controller 12 instead of the commercial power source 50. Thus, the backup power source 123 is a power source that temporarily supplies alternative power during a power failure. The backup power source 123 allows the power controller 12 to continue operation for a predetermined time within the range of the charging power of the backup power source 123, even when power fails. In detail, the power controller 12 operates for the predetermined time within the range of the charging power of the backup power source 123, and performs a process of stopping a nonvolatile storage unit 25. In this way, information in the database stored in the nonvolatile storage unit 25 can be protected from corruption or inconsistency in the event of a power failure. The backup power source 123 preferably has such a capacity that enables power supply for the operation of the power controller 12 for the predetermined time, power supply for the process of stopping the nonvolatile storage unit 25, and power supply for shutting down the power controller 12.

The control unit 124 generates control signals for controlling the power of each apparatus in the power control system 10 and/or information to be transmitted to the communication terminal 11, based on various information such as sensor data acquired by the communication unit 121.

The control unit 124 also stores information acquired by the communication unit 121, to manage the power of each apparatus in the power control system 10.

The power control system 10 includes the nonvolatile storage unit 25 to store various information collected by the control unit 124. The nonvolatile storage unit 25 may be externally connected to the power controller 12, or included in the power controller 12. For example, the nonvolatile storage unit 25 is flash memory, or a memory card having flash memory.

The power controller 12 includes the volatile storage unit 125 equally to store various information collected by the control unit 124. The volatile storage unit 125 is included in the power controller 12, and retains the stored information only when the power controller 12 is supplied with power.

The start determination unit 126 determines whether or not the start of the power controller 12 is allowed. When the power controller 12 is powered on, first the start determination unit 126 determines whether or not the backup power source 123 has been completely charged. In the case where the backup power source 123 has been completely charged, the start determination unit 126 determines that the start of the power controller 12 is allowed.

In the case where the backup power source 123 has not been completely charged, on the other hand, the start determination unit 126 determines whether or not the situation is an emergency. The start determination unit 126 determines whether or not to start the power controller 12, depending on whether or not the situation is an emergency. In the case where the situation is not an emergency, the start determination unit 126 suspends the start of the power controller 12 (hereafter referred to as “start suspended”). Thus, in the normal case, the power controller 12 is not started before the backup power source 123 is completely charged, and the power controller 12 can perform appropriate control with power supplied from the backup power source 123 when power fails.

In the case where the situation is an emergency, on the other hand, the start determination unit 126 determines that the start of the power controller 12 is allowed (hereafter referred to as “start allowed”).

The emergency situation mentioned here means such a situation that requires emergency start of the power controller 12. In detail, the emergency situation includes the case where the current time is in a final part of a reference period that is used when calculating the current power consumption of the load apparatuses in the consumer's facility and the power bills of the consumer's facility and electric power company.

The reference period (demand time limit) is a period on which contract power agreed upon between a business operator of a shop or the like (consumer) and an electric power company is based. For example, in the case where the reference period is 30 minutes and the contract power is 300 kw, the business operator is permitted to consume 300 kw of power on average in the reference period. In the case where the reference period is 30 minutes, for example, the final part of the reference period is the last 10 minutes, i.e. between 20 minutes and 30 minutes. Alternatively, the final part of the reference period may be the last 5 minutes, i.e. between 25 minutes and 30 minutes. The start determination unit 126 determines whether or not the current time is in the final part of the reference period, by acquiring time-related information from the smart meter 13. Alternatively, the start determination unit 126 may determine whether or not the current time is in the final part of the reference period, using a system clock included in the power controller 12. In the final part of the reference period, the possibility that the power usage is close to the permissible power usage limit is high. In this case, it is preferable to control the power consumption by the power controller 12, in order to keep the power usage within the limit. The emergency situation accordingly includes the case where the current time is in the final part of the reference period, and the start determination unit 126 determines “start allowed” in this case.

The emergency situation also includes the case where a prediction value of the power usage (hereafter referred to as “predicted power usage”) within the reference period based on sensor data before the power failure is greater than or equal to a set value. In detail, the start determination unit 126 acquires sensor data before the power failure, from the nonvolatile storage unit 25. The start determination unit 126 then calculates the predicted power usage within the reference period, based on the sensor data before the power failure. The start determination unit 126 determines whether or not the calculated predicted power usage is greater than or equal to the set value. The set value is preferably the power usage permissible within the reference period, but is not limited to such. For example, the set value may be less than the permissible power usage. In detail, the set value may be about 80% of the permissible power usage. In the case where the predicted power usage is greater than or equal to the set value, the possibility that the permissible power usage within the reference period is exceeded is relatively high, and so it is preferable to control the power consumption by the power controller 12. The emergency situation accordingly includes the case where the predicted power usage within the reference period is greater than or equal to the set value, and the start determination unit 126 determines “start allowed” in this case.

The emergency situation also includes, for example, the case where the power storage 16 is not discharging. In detail, the start determination unit 126 acquires information relating to the state of the power storage 16 before the power failure, which has been stored in the nonvolatile storage unit 25 before the power failure. The start determination unit 126 determines whether or not the power storage 16 is discharging, based on the information relating to the state of the power storage 16 before the power failure. In the case where the power storage 16 is not discharging, the start determination unit 126 determines “start allowed”. In the case where the power storage 16 is not discharging, the power usage in the reference period tends to increase because the power storage 16 supplies no power to the system. Therefore, the possibility that the permissible power usage limit is exceeded is high. In the case where the power storage 16 is charging, power is used to charge the power storage 16, which further increases the possibility that the permissible power usage limit is exceeded. The emergency situation accordingly includes the case where the power storage 16 is not discharging, and the start determination unit 126 determines “start allowed” in this case.

The emergency situation equally includes the case where the power generator is not discharging. In detail, the start determination unit 126 acquires information relating to the state of the power generator before the power failure, which has been stored in the nonvolatile storage unit 25 before the power failure. The start determination unit 126 determines whether or not the power generator is discharging, based on the information relating to the state of the power generator before the power failure. In the case where the power generator is not discharging, the start determination unit 126 determines “start allowed”. In the case where the power generator is not discharging, the power usage in the reference period tends to increase because the power generator supplies no power to the system. Therefore, the possibility that the permissible power usage limit is exceeded is high. The emergency situation accordingly includes the case where the power generator is not discharging, and the start determination unit 126 determines “start allowed” in this case.

The emergency situation also includes, for example, the case where the power generation of the solar power generator 15 is less than a predetermined amount. In detail, the start determination unit 126 acquires information relating to the power generation of the solar power generator 15 before the power failure, which has been stored in the nonvolatile storage unit 25 before the power failure. The start determination unit 126 determines whether or not the power generation of the solar power generator 15 is less than the predetermined amount, based on the information relating to the power generation of the solar power generator 15 before the power failure. In the case where the power generation of the solar power generator 15 is less than the predetermined amount, the start determination unit 126 determines “start allowed”. In the case where the power generation of the solar power generator 15 is less than the predetermined amount, the power usage in the reference period tends to increase because the solar power generator 15 does not supply much power to the system. Therefore, the possibility that the permissible power usage limit is exceeded is high. The emergency situation accordingly includes the case where the power generation of the solar power generator 15 is less than the predetermined amount, and the start determination unit 126 determines “start allowed” in this case.

The emergency situation also includes the case where the power usage reduction instruction is issued. In detail, the start determination unit 126 acquires information relating to the power usage reduction instruction, which has been stored in the nonvolatile storage unit 25 before the power failure. The start determination unit 126 determines whether or not the current time belongs to the duration in which power reduction is requested, that is, whether or not the power usage reduction instruction is issued. The current time is determined based on the system clock included in the power controller 12.

In the case where the power usage reduction instruction is issued, it is preferable to control the power consumption by the power controller 12. The emergency situation accordingly includes the case where the power usage reduction instruction is issued, and the start determination unit 126 determines “start allowed” in this case.

In the case where the start determination unit 126 determines “start allowed”, the power controller 12 starts operation, and the control unit 124 acquires sensor data. Preferably, the control unit 124 acquires only sensor data (hereafter referred to as “important sensor data”) necessary to control the power consumption in the power control system 10 from among all sensor data, via the communication unit 121. The important sensor data is, for example, demand pulses. By acquiring and storing only the important sensor data, the capacity of the volatile storage unit 125 can be saved, and the size and cost of the volatile storage unit 125 can be reduced. It is assumed in this embodiment that the control unit 124 acquires only the important sensor data.

The control unit 124 then determines whether or not the backup power source 123 has been completely charged. In the case where the backup power source 123 has not been completely charged, the control unit 124 stores the acquired important sensor data in the volatile storage unit 125.

In the case where the backup power source 123 has been completely charged, the control unit 124 stores sensor data in the nonvolatile storage unit 25. In detail, in the case where data is stored in the volatile storage unit 125, the control unit 124 moves the data to the nonvolatile storage unit 25 to store the data in the nonvolatile storage unit 25. The control unit 124 also stores acquired important sensor data in the nonvolatile storage unit 25. The control unit 124 further acquires sensor data other than the important sensor data via the communication unit 121, and stores the acquired sensor data in the nonvolatile storage unit 25. The sensor data other than the important sensor data is such sensor data that is not necessary for controlling the power consumption in the power control system 10.

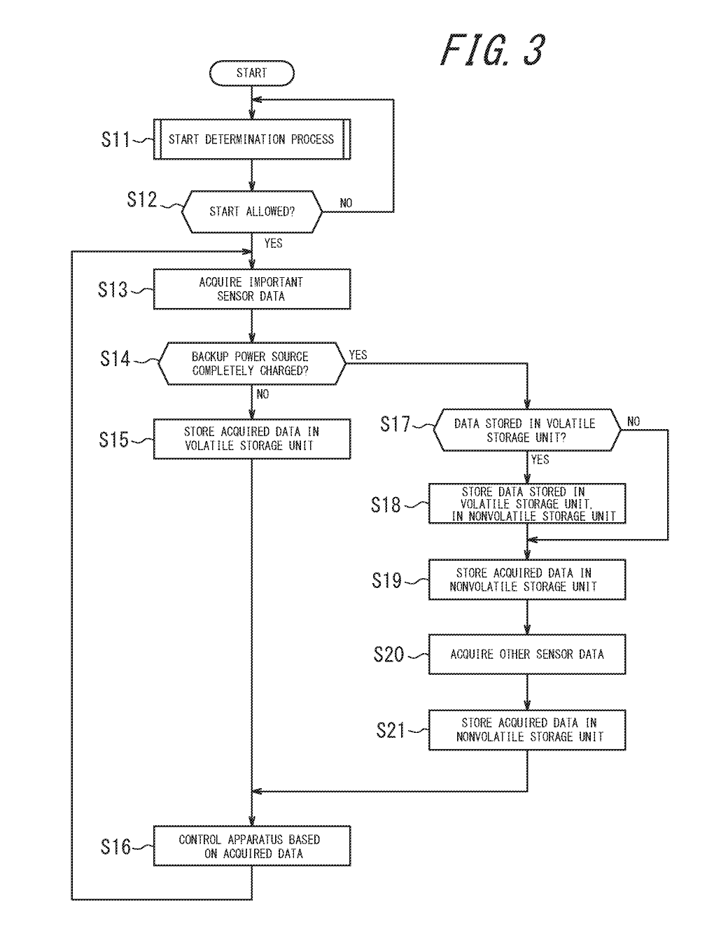

The following describes the operation of the power controller 12 according to one of the disclosed embodiments, with reference to a flowchart in FIG. 3. The flowchart in FIG. 3 illustrates the operation following when power is restored after a power failure and the power controller 12 is powered on.

First, when the power controller 12 is powered on, the start determination unit 126 determines whether or not the start of the power controller 12 is allowed (step S11). The operation relating to this determination will be described later.

In the case where the start determination unit 126 determines that the start of the power controller 12 is allowed in the start determination process (step S12: YES), the control unit 124 starts the power controller 12, and acquires important sensor data via the communication unit 121 (step S13). In the case where the start determination unit 126 determines that the start of the power controller 12 is not allowed in the start determination process (step S12: NO), the operation returns to step S11 and the start determination process is performed again.

Following step S13, the control unit 124 determines whether or not the backup power source 123 has been completely charged (step S14). In the case where the control unit 124 determines that the backup power source 123 has not been completely charged, the control unit 124 stores the acquired important sensor data in the volatile storage unit 125 (step S15). The control unit 124 then controls the load apparatuses 18 and the like based on the acquired important sensor data (step S16). The operation then returns to step S13.

In the case where the control unit 124 determines that the backup power source 123 has been completely charged in step S14, on the other hand, the control unit 124 determines whether or not data is stored in the volatile storage unit 125 (step S17). In the case where the control unit 124 determines that data is stored in the volatile storage unit 125, the control unit 124 moves the data stored in the volatile storage unit 125 to the nonvolatile storage unit 25 to store the data in the nonvolatile storage unit 25 (step S18). In the case where the control unit 124 determines that no data is stored in the volatile storage unit 125 in step S17, the control unit 124 skips step S18.

Following step S17 or S18, the control unit 124 stores the important sensor data acquired in step S13, in the nonvolatile storage unit 25 (step S19).

Following this, the control unit 124 acquires sensor data other than the important sensor data via the communication unit 121 (step S20), and stores the acquired data in the nonvolatile storage unit 25 (step S21). The operation then proceeds to step S16, where the control unit 124 controls the load apparatuses 18 and the like based on the acquired important sensor data.

Although FIG. 3 illustrates the case where the important sensor data and the sensor data other than the important sensor data are separately stored in the nonvolatile storage unit 25 or the volatile storage unit 125, this is not a limitation. Sensor data including all of the important sensor data and the sensor data other than the important sensor data may be stored in the nonvolatile storage unit 25 or the volatile storage unit 125. In this case, the control unit 124 acquires the sensor data in step S13, and stores the acquired sensor data in the volatile storage unit 125 in step S15. The control unit 124 also stores the sensor data acquired in step S13 in the nonvolatile storage unit 25 in step S19. Steps S20 and S21 are omitted.

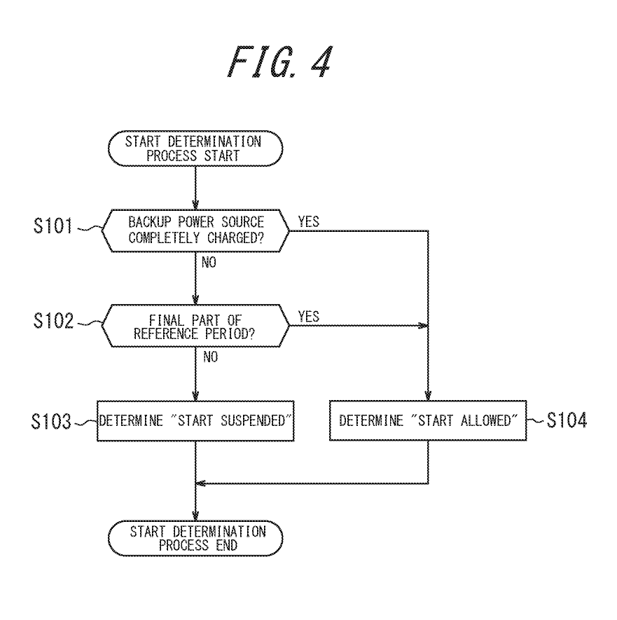

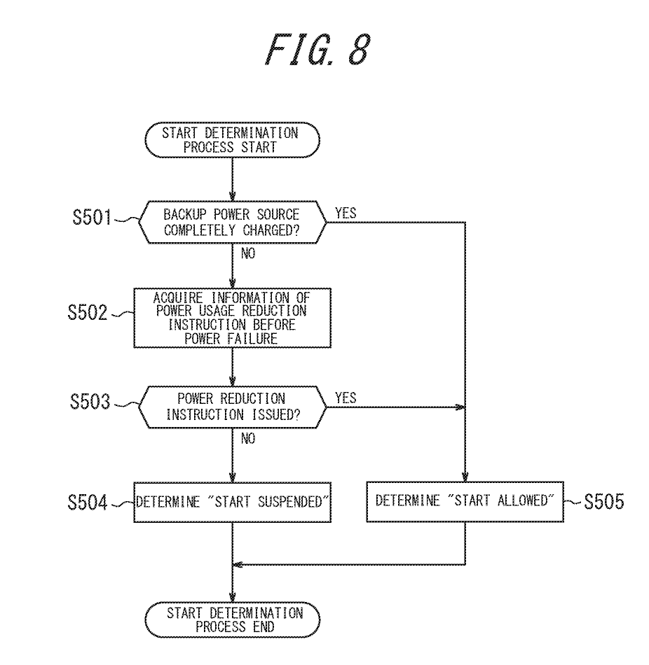

The following describes the start determination process in FIG. 3 in more detail, with reference to flowcharts in FIGS. 4 and 8. FIG. 4 is a flowchart illustrating a first example of the start determination process. First, the start determination unit 126 determines whether or not the backup power source 123 has been completely charged (step S101).

In the case where the start determination unit 126 determines that the backup power source 123 has not been completely charged, the start determination unit 126 determines whether or not the current time is in the final part of the reference period (step S102). In the case where the current time is not in the final part of the reference period, the start determination unit 126 determines “start suspended” (step S103), and ends the start determination process.

In the case where the start determination unit 126 determines that the backup power source 123 has been completely charged in step S101 or in the case where the start determination unit 126 determines that the current time is in the final part of the reference period in step S102, the start determination unit 126 determines “start allowed” (step S104), and ends the start determination process.

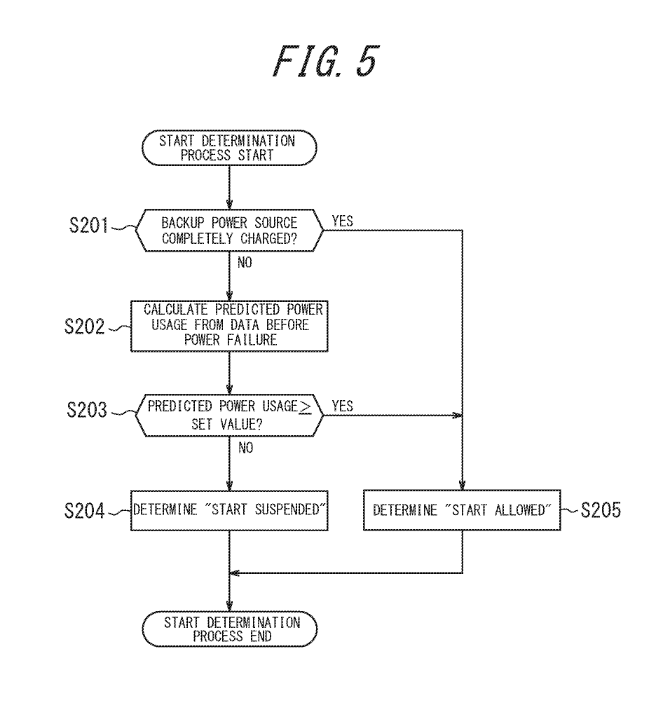

FIG. 5 is a flowchart illustrating a second example of the start determination process. First, the start determination unit 126 determines whether or not the backup power source 123 has been completely charged (step S201). In the case where the start determination unit 126 determines that the backup power source 123 has not been completely charged, the start determination unit 126 acquires sensor data before the power failure from the nonvolatile storage unit 25 (step S202). The start determination unit 126 then calculates the predicted power usage within the reference period, based on the sensor data before the power failure. The start determination unit 126 determines whether or not the calculated predicted power usage is greater than or equal to the set value (step S203). In the case where the start determination unit 126 determines that the calculated predicted power usage is not greater than or equal to the set value, the start determination unit 126 determines “start suspended” (step S204), and ends the start determination process.

In the case where the start determination unit 126 determines that the backup power source 123 has been completely charged in step S201 or in the case where the start determination unit 126 determines that the calculated predicted power usage is greater than or equal to the set value in step S203, the start determination unit 126 determines “start allowed” (step S205), and ends the start determination process.

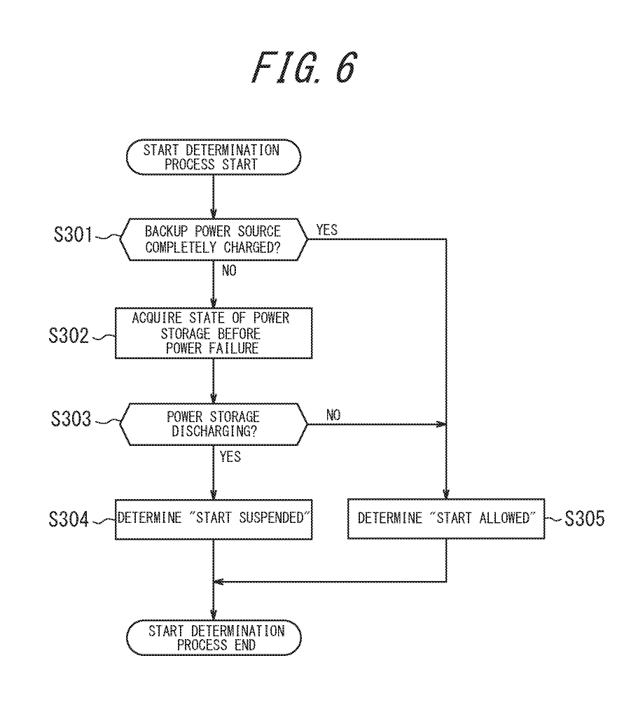

FIG. 6 is a flowchart illustrating a third example of the start determination process. First, the start determination unit 126 determines whether or not the backup power source 123 has been completely charged (step S301). In the case where the start determination unit 126 determines that the backup power source 123 has not been completely charged, the start determination unit 126 acquires information relating to the state of the power storage 16 before the power failure, which has been stored in the nonvolatile storage unit 25 before the power failure (step S302). The start determination unit 126 determines whether or not the power storage 16 is discharging, based on the information relating to the state of the power storage 16 before the power failure (step S303). In the case where the start determination unit 126 determines that the power storage 16 is discharging, the start determination unit 126 determines “start suspended” (step S304), and ends the start determination process.

In the case where the start determination unit 126 determines that the backup power source 123 has been completely charged in step S301 or in the case where the start determination unit 126 determines that the power storage 16 is discharging in step S303, the start determination unit 126 determines “start allowed” (step S305), and ends the start determination process.

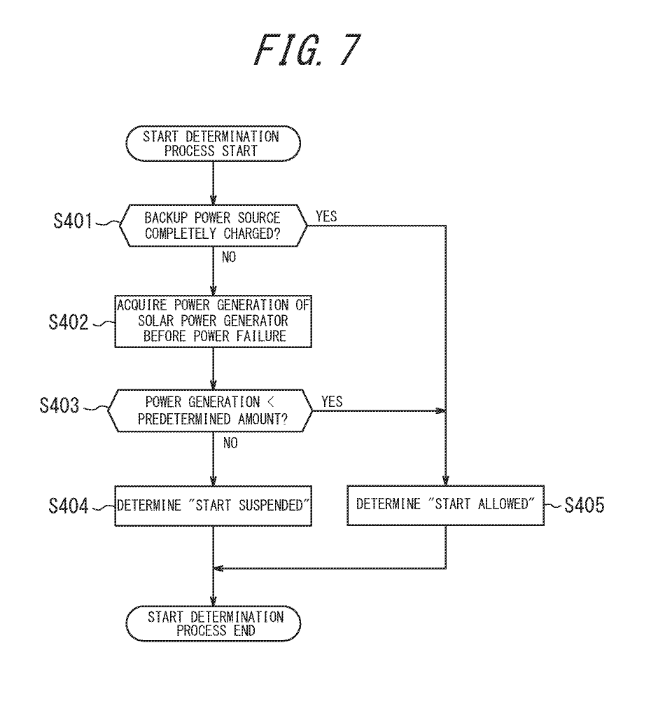

FIG. 7 is a flowchart illustrating a fourth example of the start determination process. First, the start determination unit 126 determines whether or not the backup power source 123 has been completely charged (step S401). In the case where the start determination unit 126 determines that the backup power source 123 has not been completely charged, the start determination unit 126 acquires information relating to the power generation of the solar power generator 15 before the power failure, which has been stored in the nonvolatile storage unit 25 before the power failure (step S402). The start determination unit 126 determines whether or not the power generation of the solar power generator 15 is less than the predetermined amount, based on the information relating to the power generation of the solar power generator 15 before the power failure (step S403). In the case where the start determination unit 126 determines that the power generation of the solar power generator 15 is not less than the predetermined amount (i.e. is greater than or equal to the predetermined amount), the start determination unit 126 determines “start suspended” (step S404), and ends the start determination process.

In the case where the start determination unit 126 determines that the backup power source 123 has been completely charged in step S401 or in the case where the start determination unit 126 determines that the power generation of the solar power generator 15 is less than the predetermined amount in step S403, the start determination unit 126 determines “start allowed” (step S405), and ends the start determination process.

FIG. 8 is a flowchart illustrating a fifth example of the start determination process. First, the start determination unit 126 determines whether or not the backup power source 123 has been completely charged (step S501). In the case where the start determination unit 126 determines that the backup power source 123 has not been completely charged, the start determination unit 126 acquires information relating to the power reduction instruction, which has been stored in the nonvolatile storage unit 25 before the power failure (step S502). The start determination unit 126 determines whether or not the current time belongs to in the duration in which power reduction is requested, that is, whether or not the power usage reduction instruction is issued (step S503). In the case where the start determination unit 126 determines that the power usage reduction instruction is not issued, the start determination unit 126 determines “start suspended” (step S504), and ends the start determination process.

In the case where the start determination unit 126 determines that the backup power source 123 has been completely charged in step S501 or in the case where the start determination unit 126 determines that the power usage reduction instruction is issued in step S503, the start determination unit 126 determines “start allowed” (step S505), and ends the start determination process.

Thus, according to the disclosure, the power controller 12 includes the backup power source 123 such as a capacitor. In the emergency situation such as when the current time is in the final part of the reference period, the power controller 12 is started. Moreover, the sensor data is stored in the volatile storage unit 125 while the backup power source 123 is being charged, and stored in the nonvolatile storage unit 25 after the backup power source 123 is completely charged. In a situation other than the emergency situation, the power controller 12 is started after the backup power source 123 is completely charged. Thus, the power controller 12 can operate promptly depending on the situation after a power failure.

(Modifications)

Although the above embodiment describes the case where the acquired sensor data is stored in the nonvolatile storage unit 25 or volatile storage unit 125 of the power controller 12, this is not a limitation. For example, the power controller 12 may transmit the acquired data to an external server (server) via the network 70, and store (back up) the data in the external server. In this case, the control unit 124 in the power controller 12 transmits the sensor data to the server at intervals of a predetermined time (first predetermined time). In the case where the start determination unit 126 determines to start the power controller 12, the controller 124 transmits the sensor data to the server at intervals of a predetermined time (second predetermined time) shorter than the first predetermined time, while the backup power source 123 is being charged. In other words, the cycle in which the data is transmitted to the server is shorter while the backup power source 123 is being charged. Hence, in the event of a power failure, though the data stored in the volatile storage unit 125 is lost, the data lost from the volatile storage unit 125 can be restored based on the data transmitted to and stored in the server.

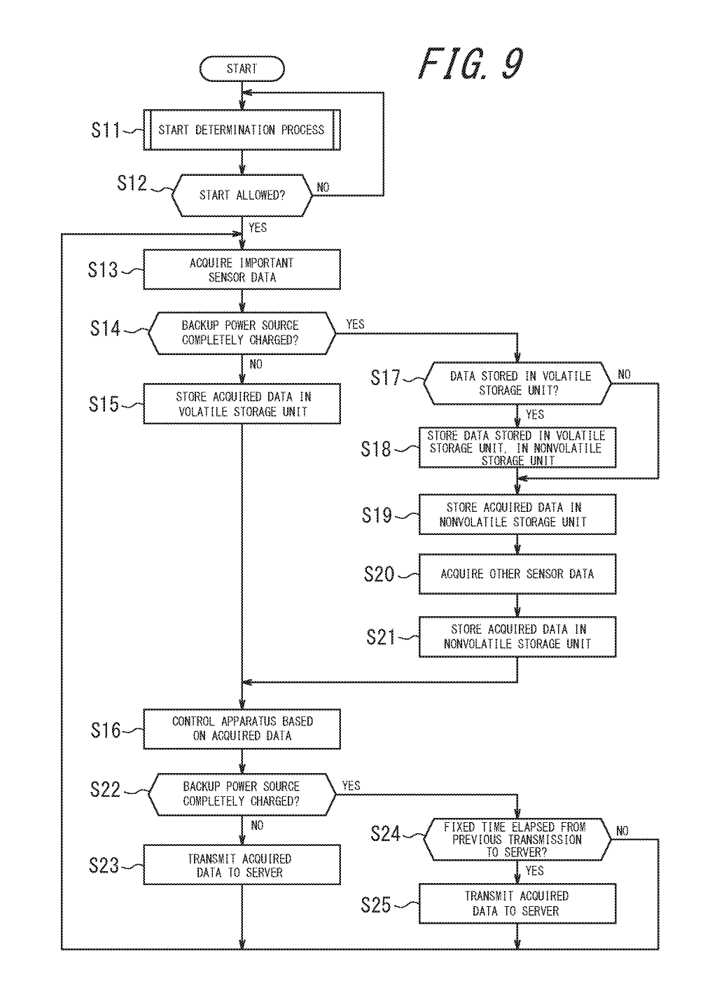

The operation of the power controller 12 according to this modification is described below, with reference to a flowchart in FIG. 9. The same steps as those in FIG. 3 are given the same reference signs, and their description is omitted.

Following step S16, the control unit 124 in the power controller 12 according to this modification determines whether or not the backup power source 123 has been completely charged (step S22). In the case where the control unit 124 determines that the backup power source 123 has not been completely charged, the control unit 124 transmits the important sensor data acquired in step S13, to the server via the network 70 (step S23). The operation then returns to step S13. The time from step S13 to step S23 corresponds to the second predetermined time.

In the case where the control unit 124 determines that the backup power source 123 has been completely charged in step S22, the control unit 124 determines whether or not a fixed time (the first predetermined time) has elapsed from the previous transmission of the acquired data to the server. In the case where the fixed time has elapsed from the previous transmission of the acquired data to the server, the control unit 124 transmits the acquired data to the server (step S25). The operation then returns to step S13.

Thus, the power controller 12 according to this modification stores the acquired sensor data in the external server. Here, in the case where the backup power source 123 has not been completely charged, the power controller 12 transmits the acquired sensor data to the server with high frequency, to store the sensor data in the server. This lowers the possibility that the acquired data is lost.

A computer may be suitably used to function as the power controller 12. In detail, the power controller 12 can be realized by a central processing unit (CPU) or DSP of the computer reading and executing a program which is stored in a storage medium of the computer and in which the processes for achieving the functions of the power controller 12 are written.

Although the disclosed apparatus, method, and system have been described by way of the drawings and embodiments, various changes and modifications may be easily made by those of ordinary skill in the art based on the disclosure. Such various changes and modifications are therefore included in the scope of the disclosure. For example, the functions included in the means, steps, etc. may be rearranged without logical inconsistency, and a plurality of means, steps, etc. may be combined into one means, step, etc. and a means, step, etc. may be divided into a plurality of means, steps, etc.

### REFERENCE SIGNS LIST

10 power control system
11 communication terminal
12 power controller
13 smart meter
14 power supply
15 solar power generator
16 power storage
17 distribution board
18 load apparatus
25 nonvolatile storage unit
50 commercial power source
60 grid EMS
61 storage medium
70 network
121 communication unit
122 power input unit
123 backup power source
124 control unit
125 volatile storage unit
126 start determination unit

1. A power controller installed in a consumer's facility to manage a power state of a load apparatus or a dispersed power source in the consumer's facility, the power controller comprising:
a communication unit configured to acquire sensor data relating to the load apparatus or the dispersed power source;
a nonvolatile storage unit and a volatile storage unit each configured to store the sensor data;
a control unit configured to control the load apparatus or the dispersed power source based on the sensor data; and
a backup power source that is charged with a commercial power source, and supplies power during a power failure,
wherein the control unit is configured to, when starting the power controller after the power failure, store the sensor data in the volatile storage unit while the backup power source is being charged, and store the sensor data in the nonvolatile storage unit after the backup power source is completely charged.

2. The power controller according to claim 1,
wherein a condition for the control unit starting the power controller after the power failure includes a situation where current time is in a final part of a reference period for measuring power usage.

3. The power controller according to claim 1,
wherein a condition for the control unit starting the power controller after the power failure includes a situation where predicted power usage within a reference period based on the sensor data before the power failure is greater than or equal to a set value.

4. The power controller according to claim 1,
wherein the dispersed power source includes a power storage, and
a condition for the control unit starting the power controller after the power failure includes a situation where the power storage is not discharging.

5. The power controller according to claim 1,
wherein the dispersed power source includes a power generator, and
a condition for the control unit starting the power controller after the power failure includes a situation where the power generator is not discharging.

6. The power controller according to claim 1,
wherein the dispersed power source includes a solar power generator, and
a condition for the control unit starting the power controller after the power failure includes a situation where power generation of the solar power generator is less than a predetermined amount.

7. The power controller according to claim 1,
wherein a condition for the control unit starting the power controller after the power failure includes a situation where a power usage reduction instruction is issued.

8. The power controller according to claim 1,
wherein the control unit is configured to, when starting the power controller after the power failure, store only a part of the sensor data in the volatile storage unit while the backup power source is being charged.

9. The power controller according to claim 1, further transmitting the sensor data to a server,
wherein the control unit is configured to, when starting the power controller after the power failure, transmit the sensor data to the server at intervals of a first predetermined time in the case where the backup power source has been completely charged, and transmit the sensor data to the server at intervals of a second predetermined time while the backup power source is being charged, the second predetermined time being shorter than the first predetermined time.

10. A power control method by a power controller installed in a consumer's facility to manage a power state of a load apparatus or a dispersed power source in the consumer's facility,
wherein the power controller includes:
a communication unit configured to acquire sensor data relating to the load apparatus or the dispersed power source;
a nonvolatile storage unit and a volatile storage unit each configured to store the sensor data;
a control unit configured to control the load apparatus or the dispersed power source based on the sensor data; and
a backup power source that is charged with a commercial power source, and supplies power during a power failure, and
the power control method includes steps of, when starting the power controller after the power failure:
storing the sensor data in the volatile storage unit while the backup power source is being charged; and
storing the sensor data in the nonvolatile storage unit after the backup power source is completely charged.

11. The power control method according to claim 10,
wherein a condition for the control unit starting the power controller after the power failure includes a situation where current time is in a final part of a reference period for measuring power usage.

12. The power control method according to claim 10,
wherein a condition for the control unit starting the power controller after the power failure includes a situation where predicted power usage within a reference period based on the sensor data before the power failure is greater than or equal to a set value.

13. The power control method according to claim 10,
wherein the dispersed power source includes a power storage, and
a condition for the control unit starting the power controller after the power failure includes a situation where the power storage is not discharging.

14. A power control system comprising: a load apparatus or a dispersed power source in a consumer's facility; and a power controller for managing a power state of the load apparatus or the dispersed power source,
wherein the power controller includes:
a communication unit configured to acquire sensor data relating to the load apparatus or the dispersed power source;
a nonvolatile storage unit and a volatile storage unit each configured to store the sensor data;
a control unit configured to control the load apparatus or the dispersed power source based on the sensor data; and
a backup power source that is charged with a commercial power source, and supplies power during a power failure, and
the control unit is configured to, when starting the power controller after the power failure, store the sensor data in the volatile storage unit while the backup power source is being charged, and store the sensor data in the nonvolatile storage unit after the backup power source is completely charged.

15. The power control system according to claim 14,
wherein the power controller further transmits the sensor data to a server, and
the control unit is configured to, when starting the power controller after the power failure, transmit the sensor data to the server at intervals of a first predetermined time in the case where the backup power source has been completely charged, and transmit the sensor data to the server at intervals of a second predetermined time while the backup power source is being charged, the second predetermined time being shorter than the first predetermined time.
